(19) United States
(12) Patent Application Publication
(10) Pub. No.: US 2008/0021938 A1
(43) Pub. Date: Jan. 24, 2008

(54) Technique for allocating objects in a managed run time environment

(76) Inventor: Ashish Jha, Hillsboro, OR (US)

Correspondence Address: TROP PRUNER & HU, PC, 1616 S. VOSS ROAD, SUITE 750, HOUSTON, TX, 77057-2631, US

(21) Appl. No.: 11/478,964

(22) Filed: Jun. 29, 2006

(51) Int. Cl. G06F 17/30

(52) U.S. Cl. 707/205

(57) ABSTRACT

A technique includes allocating memory for software objects. The allocation includes resizing at least some of the objects so that the size of each of the objects is a multiple of an integer.

### BACKGROUND

The invention generally relates to a technique to allocate objects in a managed run time environment.

In a conventional managed run time environment, such as a JAVA® environment (as an example), many temporary software objects (herein called “objects”) are created, used and subsequently destroyed. Security specifications for JAVA® typically set forth that the memory must be “clean” before it is used. This typically means that in the process of allocating an object, the JAVA® virtual machine clears a memory region with zeros before the object is stored in the memory region. Even allocating a new object that is a copy of an old object first involves a memory clear operation. A significant amount of time and system resources may be consumed clearing memory for purposes of object allocation.

Thus, there exists a continuing need for better ways to allocate software objects.

### BRIEF DESCRIPTION OF THE DRAWING

FIG. 1 is a block diagram of a virtual machine according to an embodiment of the invention.

FIG. 2 is a block diagram of a memory manager according to an embodiment of the invention.

FIG. 3 is an illustration depicting realignment of an object according to an embodiment of the invention.

FIG. 4 is a flow diagram depicting a technique to allocate an object according to an embodiment of the invention.

FIG. 5 is a flow diagram depicting a technique to determine an object multiplication factor according to an embodiment of the invention.

FIG. 6 is a flow diagram depicting a technique to perform clear and copy operations in association with the allocation of an object according to an embodiment of the invention.

FIG. 7 is a schematic diagram of a computer system according to an embodiment of the invention.

### DETAILED DESCRIPTION

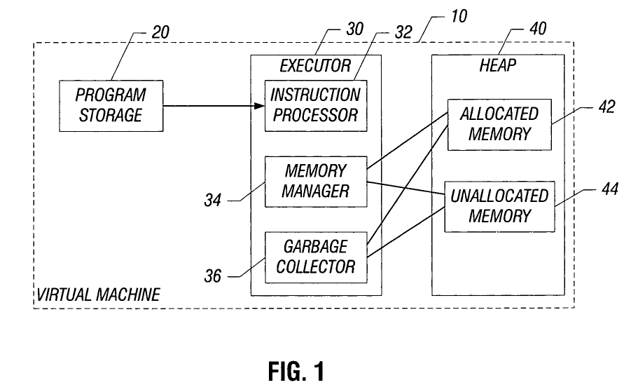

Referring to FIG. 1, an embodiment 10 of a virtual machine (a JAVA® virtual machine, for example) in accordance with the invention includes program storage 20, an executor 30 and a heap 40. The program storage 20 stores program instructions (JAVA® byte code, for example) that are executed by an instruction processor 32 of the executor 30. The execution of the instructions by the instruction processor 32 may cause the allocation of various software objects (herein called “objects).

Once allocated, objects reside in allocated memory 42 of the heap 40. However, the allocation of an object may involve copy and clear operations, which until the copy and clear operations are complete, are directed to an unallocated memory 44 of the heap 40. The unallocated memory 44 may be created by a garbage collector 36 (of the executor 30), which monitors allocated objects (stored in the allocated memory 42) for purposes of determining when a particular object is no longer being used; and when the garbage collector 36 identifies a particular object as being unused, the garbage collector 36 transfers (or remaps) the previously allocated memory for the object into the unallocated memory 44. The garbage collector 36 may clear the newly-created unallocated region of the unallocated memory 44, in accordance with some embodiments of the invention. However, in other embodiments of the invention, described below, the garbage collector 36 leaves the clear operation to a memory manager 34 (of the executor 30), which performs both clear and possibly object copy operations in connection with the allocation of each object.

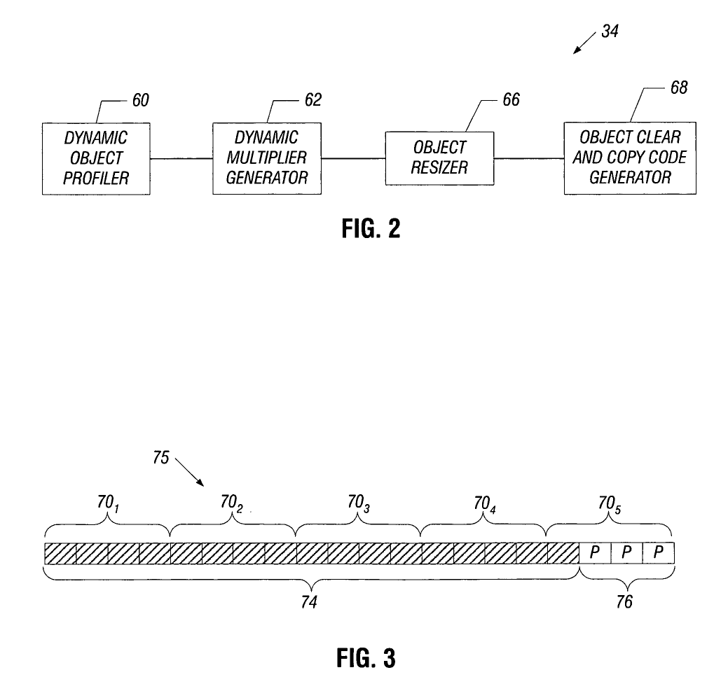

Referring to FIG. 2 in conjunction with FIG. 1, in accordance with some embodiments of the invention, the memory manager 34, resizes objects and selects algorithms that are used for the clear and copy operations for purposes of improving the efficiency of object allocation. To perform these tasks, the memory manager 34 includes a dynamic object profiler 60, which profiles object allocation heuristics, to produce information that the memory manager 34 uses to resize objects for purposes of aligning the objects to coincide with predefined memory boundaries.

More specifically, in accordance with some embodiments of the invention, an object multiplier generator 62 of the memory manager 34 uses the information that is provided by the dynamic object profiler 60 to determine a particular unit size (called an “object multiplier” herein), or granularity, for all of the allocated objects. The resizing of objects by the memory manager 34 creates memory boundaries, such as DWORD, QWORD or DQWORD boundaries (i.e., memory addresses are aligned to coincide with one of the boundaries). Thus, each allocated object is stored, beginning on one of the memory boundaries and ending on the memory location before the next memory boundary. As a result of the object resizing, operations that involve the clearing and copying of data to and from the heap 40 are optimized with respect to time, as further described below.

For purposes of resizing objects, the memory manager 34 includes an object resizer 66, which bases the size of the resized object on the object multiplier that is generated by the object multiplier generator 62. An object clear and copy code generator 68 of the memory manager 34, as further described below, selects routines to efficiently clear and copy data from the heap 40 based on the size of a particular object and the object multiplier factor.

The advantages of the object resizing and clear and copy routine selection as disclosed herein may include one or more of the following. Security specifications of JAVA® set forth that the memory for an object is to be clean (i.e., cleared with all zeros) before the object is stored in the memory, even if a new object is a copy of an old object. Therefore, more efficient clear and copy operations speed up the overall performance of the virtual machine. By replacing conventional instructions with the reduced size clear and copy operations described herein, object allocation performance is improved. Additionally, due to the resizing of the objects, as described herein, the objects are fitted to memory boundaries, thereby decreasing time to clear/copy memory, as compared to conventional techniques.

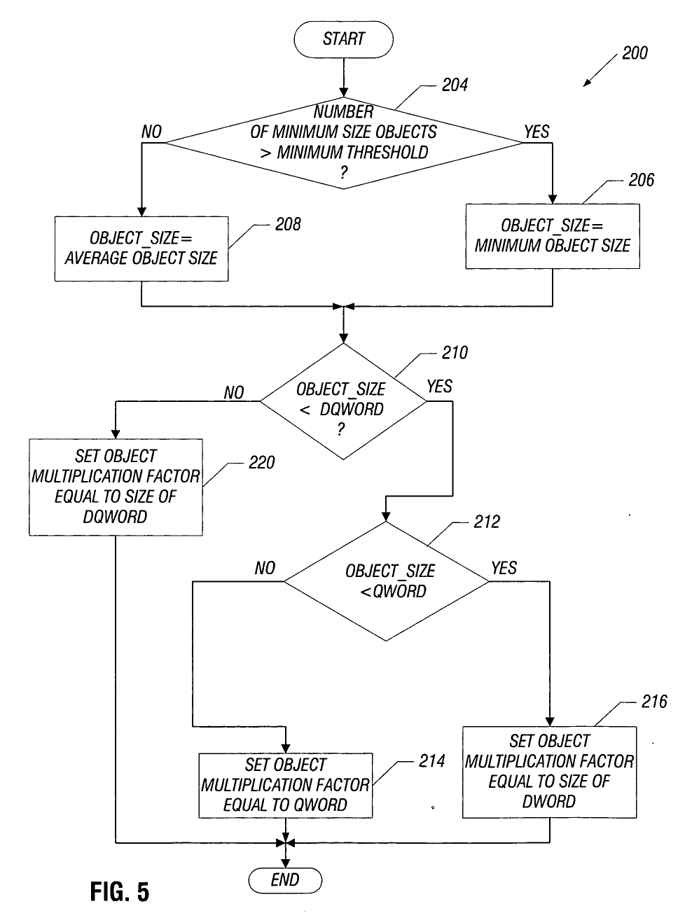

As a more specific example, FIG. 3 depicts a particular example in which an original object 74 has been resized by the object resizer 66 (FIG. 2) to produce a resized object 75. For this example, the original object 74 contains seventeen bytes, and the object multiplier is four (i.e., a basic unit size of four bytes, or one DWORD). Therefore, the original object 74 is spread out over four data units 70₁, 70₂, 70₃ and 70₄ (i.e., four bytes per unit), which contain the first sixteen bytes of the original object 74 and an additional unit 70₅, which contains the seventeenth byte of the original object 74 and three padding bytes 76. Due to this arrangement, operations may be performed on the memory boundaries that are defined at the beginning of each of the units. Thus, the starting address of each object is on a DWORD boundary. Although for this example, the resized object 75 has a granularity of four bytes, or a “DWORD,” it is noted that in other embodiments of the invention, the granularity may be different, in that the object multiplier may be a “QWORD” (eight bytes) or a “DQWORD” (sixteen bytes), as just a few examples. One way to determine the object multiplier is given by way of example below in connection with FIG. 5, although other techniques may be used to select the object multiplier in accordance with other embodiments of the invention.

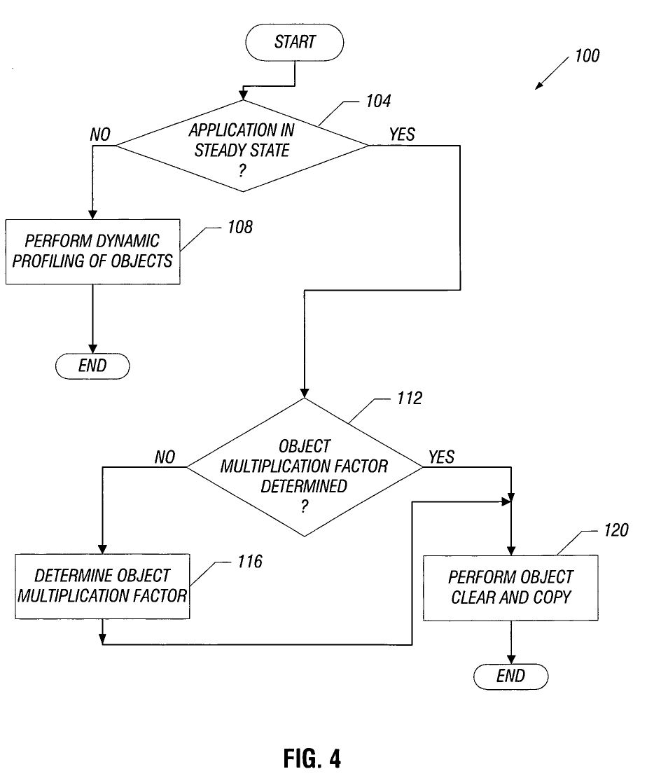

Referring to FIG. 4, in accordance with some embodiments of the invention, a technique 100 may generally be used by the memory manager 34 for purposes of allocating an object. Pursuant to the technique 100, the memory manager 34 determines (diamond 104) whether the application that generates the objects is in steady state, i.e., determines if the application is executing and is past the point of being loaded and initialized. If the application is not in steady state, then the memory manager 34 performs dynamic profiling of objects, pursuant to block 108. As an example, in this profiling, the memory manager 34 may determine the average object size, the minimum object size, the maximum object size, etc. If the application is in steady state, then the memory manager 34 determines (diamond 112) whether the object multiplication factor has been determined. If the object multiplication factor has not been determined, the memory manager 34 determines (block 116) the object multiplication factor. The memory manager 34 then performs (block 120) object clear and copy operations that are associated with allocating the object.

Referring to FIG. 5, in accordance with some embodiments of the invention, the memory manager 34 may perform a technique 200 for purposes of determining the object multiplication factor. Pursuant to the technique 200, the memory manager 34 determines (diamond 204) the number of minimum size objects that are above a predefined minimum threshold. The memory manager 34 then uses the determination made in diamond 204 for purposes of establishing a value of an intermediary object variable called “OBJECT_SIZE.” More specifically, if the memory manager 34 determines pursuant to diamond 204, that the number of minimum size objects is greater than the minimum threshold, then the memory manager 34 sets (block 206) the OBJECT_SIZE variable equal to a minimum object size. Otherwise, if the memory manager 34 determines pursuant to diamond 204 that the number of minimum size objects is less than or equal to the minimum threshold, then the memory manager 34 sets the OBJECT_SIZE variable equal to the average OBJECT_SIZE, pursuant to block 208.

Subsequently, pursuant to the technique 200, the memory manager 34 evaluates the object size (as indicated by the OBJECT_SIZE variable) to determine the object multiplication factor. In this example, the memory manager 34 selects between three different multiplication factors (a DWORD, QWORD and DQWORD factor, as examples). This selection, in this embodiment of the invention, attempts to establish the object multiplication factor to be the factor that is the closest to the size indicated by the OBJECT_SIZE variable, without exceeding the size.

More specifically, pursuant to the technique 200, the memory manager 34 determines (diamond 210) whether the OBJECT_SIZE variable is less than a DQWORD. If not, the memory manager 34 sets (block 220) the object multiplication factor equal to the size of a DQWORD (i.e., equal to sixteen).

If the memory manager 34 determines (diamond 210) that the OBJECT_SIZE variable is greater or equal to a DQWORD, then the memory manager 34 determines (diamond 212) whether the object size is less than a QWORD. If so, the memory manager 34 sets the object multiplication factor equal to the size of a DWORD (i.e., equal to eight), pursuant to block 216. Otherwise, the memory manager 34 sets the object multiplication factor equal to a QWORD, pursuant to block 214.

For purposes of optimizing the performance of the operations that are directed to clearing and copying memory in association with the object allocation, the memory manager 34 selects whether a rolled, or looped; or an unrolled, or non-looped, routing is used. A looped routine is a routine in which the program instructions are executed in a software loop for purposes of performing the clear or copy operation. Conversely, a non-looped routine is a routine in which the copy or clear operation does not involve executing software instructions in a software loop.

More specifically, in accordance with some embodiments of the invention, the memory manager 34 may use the following non-looped routine to clear memory for a relatively small object:

OBJ_CLEAR_FUNC_UNROLL:
Mov DWORD PTR [edi], 0h
Mov DWORD PTR [edi+4], 0h
Mov DWORD PTR [edi+8], 0h
Mov DWORD PTR [edi+16], 0h

The non-looped version of the clear routine may be beneficial for relatively small objects in which the additional code that would otherwise be used to implement a looped routine may ultimately involve more executions than its non-looped counterpart. However, for larger objects, the non-looped version may be inefficient, and thus, memory manager 34 may use a looped routine for a copy or clear operation for this object. In this regard, as an example, in accordance with some embodiments of the invention, the memory manager 34 may use a soft routine similar to the one that is set forth below for a looped clear operation:
Mov ecx, 16h
Mov edi, destination_start_address
Add edi, ecx (points to end of object)//for forward strides
Neg ecx

Loop:
Mov DWORD PTR [edi+ecx], 0h
Add ecx, 4
Jnz Loop

It is noted that the looped and non-looped copy routines are similar to the looped and non-looped clear routines that are included above, in accordance with some embodiments of the invention.

For purposes of deciding whether to execute the looped or non-looped routine, the memory manager 34 examines the size of the object to be copied, or the amount memory to be cleared in the allocation of the object. In this regard, in accordance with some embodiments of the invention, the memory manager 34 considers the final object size divided by an object multiplication factor and then compares this result to a predefined threshold.

For example, in accordance with some embodiments of the invention, the threshold that is used to determine whether to perform a looped or a non-looped clear operation may be “10,” the final object size may be 64 bytes (as an example) and the object multiplication factor may be a DWORD. For this example, the final object size divided by the multiplication factor is sixteen, which is less than the threshold. Thus, for this scenario, the looped clear operation is used in lieu of the non-looped clear operation.

The threshold for the copy operation may be different than the threshold for the clear operation, in accordance with some embodiments of the invention. For example, in accordance with some embodiments of the invention, the threshold for the copy operation may be approximately one half that of the threshold for the clear operation. Therefore, for the example given above, the final object size divided by the multiplication factor is sixteen, which is larger than five, or one half of the threshold for the clear operation.

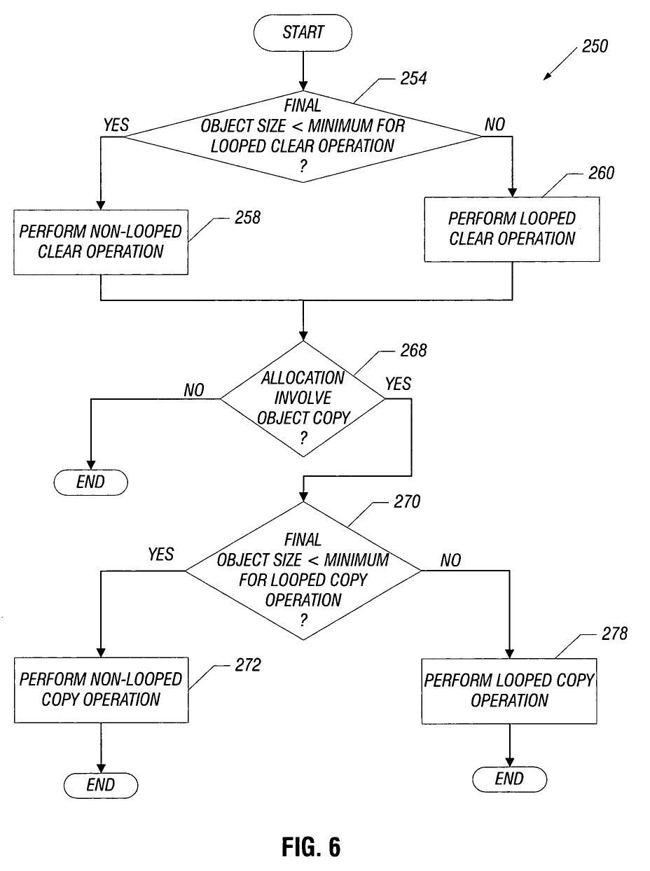

Referring to FIG. 6, therefore, in accordance with some embodiments of the invention, the memory manager 34 may perform a technique 250 that is generally depicted in FIG. 6. Pursuant to the technique 250, the memory manager 34 determines (diamond 254) whether the final object size is less than a minimum for a looped clear operation. If so, then the memory manager 34 performs a non-looped clear operation, pursuant to block 258. Otherwise, the memory manager 34 clears the memory for the new object using a looped clear operation, pursuant to block 260.

Next, the memory manager 34 determines (block 268) whether the allocation involves an object copy. If not, then the technique 250 ends. If so, then the memory manager 34 determines (diamond 270) whether the final object size is less than a minimum for a looped copy operation. If so, the memory manager 34 performs a non-looped copy operation pursuant to block 272. Otherwise, the memory manager 34 performs (block 278) a looped copy operation.

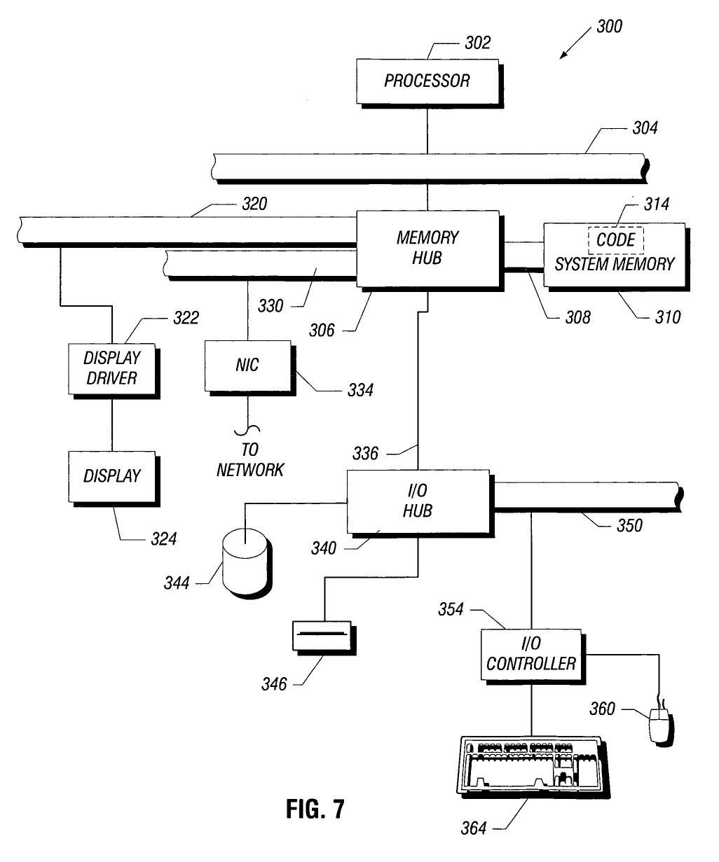

Referring to FIG. 7, in accordance with some embodiments of the invention, the software architecture that is depicted in FIG. 1 may be achieved via a computer system 300, which includes a processor 302 (one or more microprocessors or microcontrollers, as examples) which executes program code 314 that is stored in a system memory 310. Thus, the execution of the program code 314 by the processor 302 may, for example, establish the virtual machine 10 (see FIG. 1).

The computer system 300 may have a variety of different architectures, one of which is described herein for purposes of example. In this regard, the processor 302 may, along with a north bridge or memory hub 306, be coupled to a system bus 304. The memory hub 306 may, for example, provide an interface for a memory bus 308 (coupled to the system memory 310), an Accelerated Graphics Port (AGP) bus 320 and a Peripheral Component Interconnect (PCI) bus 330. The AGP is described in detail in the Accelerated Graphics Port Interface Specification, Revision 1.0, published on Jul. 31, 1996, by Intel Corporation of Santa Clara, Calif. The PCI Specification is available from The PCI Special Interest Group, Portland, Oreg. 97214.

A display driver 322 may be coupled to the AGP bus 320 for purposes of driving a display 324 of the computer system 300 and, as an example, a network interface card (NIC) 334 may be coupled to the PCI bus 330 for purposes of establishing communication for computer system 300 to a network.

A memory hub 306 may be in communication with a south bridge, or input/output (I/O) hub 340 via a hub link 336. In this regard, the I/O hub 340 may provide interfaces for a hard disk drive 344 and a CD-rom drive 346. Additionally, the I/O hub 340 may provide an interface for an I/O expansion bus 350. An I/O controller 354 may be coupled to the I/O expansion bus 350 for purposes of receiving input from a mouse 360 and a keyboard 364.

Other embodiments are within the scope of the appended claims. For example, in accordance with other embodiments of the invention, the memory manager 34 (see FIG. 1) may automate the object resizing in the following manner. When a particular object type is resized for the first time, data is stored, which sets forth data that was gathered/determined for object type by the memory manager 34. Therefore, the memory manager 34 may reuse the collected data for other similar object types to increase the speed of object allocation. For example, the first time the memory manager 34 allocates an object of the type “Employee” (as an example), the memory manager 34 may store the object multiplication factor and may store indications of whether looped or non-looped clear and copy operations were selected. Therefore, the next time the memory manager 34 allocates an Employee object, this information may be reused, thereby eliminating the need to recalculate these parameters and increasing the speed of object allocation.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
allocating memory for software objects, comprising resizing at least some of the objects so that the size of each of the objects is a multiple of an integer.

2. The method of claim 1, further comprising:
aligning storage of the software objects in the memory so that address of each of the objects is a multiple of the integer.

3. The method of claim 1, further comprising:
determining the integer, comprising evaluating sizes of the objects before the resizing.

4. The method of claim 3, wherein the evaluating comprises determining an average size of the sizes of the objects before the resizing.

5. The method of claim 3, wherein the evaluating comprises determining a minimum size of the sizes of the objects before resizing.

6. The method of claim 1, further comprising:
copying the software objects to the memory, the copying comprising, for each software object, selecting a software routine that when executed causes said each software object to be copied to the memory, the selection of the software routine being based on the size of said at least one object and the integer.

7. The method of claim 6, wherein the selecting of the software routine comprises:
selecting between a first software routine that comprises instructions that execute in a loop to copy said each software object to the memory and a second software routine that comprises instructions that do not execute in a loop to copy said each software object to the memory.

8. The method of claim 1, further comprising:
clearing at least part of the memory prior to storage of the software objects in the memory, the clearing comprising, for each software object, selecting a software routine that when executed causes memory to be cleared for storage of said each software object, the selection of the software routine being based on the size of said at least one object and the integer.

9. The method of claim 8, wherein the selecting of the software routine comprises:
selecting between a first software routine that comprises instructions that execute in a loop to clear part of the memory for said each software object and a second software routine that comprises instructions that do not execute in a loop to clear part of the memory for said each software object.

10. A system comprising:
an object multiplier generator to determine a minimum size of software objects; and
an object resizer to resize at least some of the objects so that the size of each of the objects is a multiple of the minimum size.

11. The system of claim 10, further comprising:
a memory manager to align storage of the software objects in a memory so that address of each of the objects is a multiple of the integer.

12. The system of claim 10, wherein the object multiplier generator is adapted to base the minimum size at least in part on the sizes of the objects before the resizing.

13. The system of claim 10, wherein the object multiplier generator is adapted to base the minimum size at least in part on the average size of the objects before the resizing.

14. The system of claim 10, wherein the object multiplier generator is adapted to base the minimum size at least in part on the minimum of the sizes of the objects before the resizing.

15. The system of claim 10, further comprising:
a memory manager to copy the software objects to a memory, the memory manager to, for each software object, select a software routine that when executed causes said each software object to be copied to the memory, the selection of the software routine being based on the size of said at least one object and said minimum size.

16. The system of claim 15, wherein the memory manager selects between a first software routine that comprises instructions that execute in a loop to copy said each software object to the memory and a second software routine that comprises instructions that do not execute in a loop to copy said each software object to the memory.

17. The system of claim 10, further comprising:
a memory manager to clear at least part of a memory prior to storage of the software objects in the memory, the memory manager to for each software object, select a software routine that when executed causes memory to be cleared for storage of said each software object, the selection of the software routine being based on the size of said at least one object and said minimum size.

18. The system of claim 17, wherein the memory manager selects between a first software routine that comprises instructions that execute in a loop to clear part of the memory for said each software object and a second software routine that comprises instructions that do not execute in a loop to clear part of the memory for said each software object.

19. An article comprising a computer accessible storage medium storing instructions that when executed cause a computer to:
allocate memory for software objects, the allocation comprising resizing at least some of the objects so that the size of each of the objects is a multiple of an integer

20. The article of claim 19, the storage medium storing instructions that when executed cause the computer to base the integer at least in part on the average size of the objects before the resizing.

21. The article of claim 19, the storage medium storing instructions that when executed cause the computer to for each software object, select a software routine that when executed causes said each software object to be copied to the memory, the selection of the software routine being based on the size of said at least one object and said minimum size.

22. The article of claim 21, the storage medium storing instructions that when executed cause the computer to select between a first software routine that comprises instructions that execute in a loop to copy said each software object to the memory and a second software routine that comprises instructions that do not execute in a loop to copy said each software object to the memory.

22. The article of claim 19, the storage medium storing instructions that when executed cause the computer to for each software object, select a software routine that when executed causes memory to be cleared for storage of said each software object, the selection of the software routine being based on the size of said at least one object and said minimum size.

23. The article of claim 19, the storage medium storing instructions that when executed cause the computer to select between a first software routine that comprises instructions that execute in a loop to clear part of the memory for said each software object and a second software routine that comprises instructions that do not execute in a loop to clear part of the memory for said each software object.

24. A system comprising:
a heap; and
an executor to determine a minimum size of software objects stored in the heap and resize at least some of the objects so that the size of each of the objects is a multiple of the minimum size.

25. The system of claim 24, wherein the heap and the executor are part of a virtual machine.

26. The system of claim 24, wherein the virtual machine aligns storage of the software objects in a memory so that address of each of the objects is a multiple of the minimum size.

27. The system of claim 24, wherein the executor for each software object, selects a software routine that when executed causes said each software object to be copied to the heap, the selection of the software routine being based on the size of said at least one object and said minimum size.

28. The system of claim 27, wherein the executor selects between a first software routine that comprises instructions that execute in a loop to copy said each software object to the heap and a second software routine that comprises instructions that do not execute in a loop to copy said each software object to the heap.

29. The system of claim 24, wherein the executor for each software object, selects a software routine that when executed causes memory to be cleared for storage of said each software object, the selection of the software routine being based on the size of said at least one object and said minimum size.

30. The system of claim 29, wherein the executor selects between a first software routine that comprises instructions that execute in a loop to clear part of the memory for said each software object and a second software routine that comprises instructions that do not execute in a loop to clear part of the memory for said each software object.
